(19) United States
(12) Patent Application Publication
(10) Pub. No.: US 2025/0277979 A1
(43) Pub. Date: Sep. 4, 2025

(54) VIRTUAL-IMAGE DISPLAY DEVICE AND OPTICAL UNIT

(71) Applicant: SEIKO EPSON CORPORATION, Tokyo (JP)

(72) Inventor: Takashi TAKEDA, Suwa-Shi (JP)

(73) Assignee: SEIKO EPSON CORPORATION, Tokyo (JP)

(21) Appl. No.: 19/063,349

(22) Filed: Feb. 26, 2025

(30) Foreign Application Priority Data
Feb. 29, 2024 (JP) 2024-029632

(51) Int. Cl. G02B 27/01; G02B 5/30

(52) U.S. Cl. CPC G02B 27/0172; G02B 5/3025; G02B 2027/0178

(57) ABSTRACT

A virtual-image display device or an optical unit includes: a display section configured to output image light; a first polarized-light diffraction lens disposed so as to be opposed to the display section and having a positive power for the image light of circularly polarized light; and a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that passes through the first polarized-light diffraction lens.

The present application is based on, and claims priority from JP Application Serial Number 2024-029632, filed Feb. 29, 2024, the disclosure of which is hereby incorporated by reference herein in its entirety.

### BACKGROUND

### 1. Technical Field

The present disclosure relates to a virtual-image display device and an optical unit, which make it possible to observe a virtual image, and in particular, relates to a virtual-image display device or the like using a polarized-light diffraction lens.

### 2. Related Art

There is known a virtual-image display device (WO 2016/056298) including: a liquid crystal panel including an image display region and a transparent display region formed so as to surround the image display region; and a light-guiding plate configured to guide a backlight beam entering an end portion from a light source. In the virtual-image display device, the light-guiding plate includes a light emission region configured to emit the backlight beam to the image display region of the liquid crystal panel, and also includes a light transmitting region configured to cause ambient light to pass through. This virtual-image display device makes it possible to perform see-through display in which image light and the ambient light are superimposed.

In a case of the virtual-image display device described above, when the liquid crystal panel is disposed close to and in front of the eyes, it is necessary to provide an imaging system for observing an image formed on the image display region. As such an imaging system, for example, by using an optical system of a type in which a lens or the like including a half mirror formed at one surface thereof is embedded to bend the optical path twice, it is possible to reduce the thickness of the virtual-image display device including the imaging system.

However, in a case of the imaging system of a type in which the optical path is bent twice, there is a section in which light travels in the reverse direction, and the lens is incorporated. This poses a limitation as to reducing the thickness of the imaging system, which makes it difficult to deal with a request for further reducing the thickness. In addition, in a case of the imaging system of the type in which the optical path is bent twice, this normally works on the ambient light as well. Thus, it is necessary to add a mechanism for directly passing through the ambient light.

### SUMMARY

A virtual-image display device according to one aspect of the present disclosure includes a display section configured to output image light, a first polarized-light diffraction lens disposed so as to be opposed to the display section and having a positive power for the image light of circularly polarized light, and a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that passes through the first polarized-light diffraction lens.

### BRIEF DESCRIPTION OF THE DRAWINGS

FIG. 1 is a front view illustrating the external appearance used to describe a state where a virtual-image display device according to the first embodiment is mounted.

FIG. 2 is a conceptual perspective view illustrating the structure of the virtual-image display device.

FIG. 3 is an enlarged cross-sectional side view illustrating a display section.

FIG. 4 is a diagram used to describe a state of light passing through the display section.

FIG. 5 is a side cross-sectional view used to describe an imaging system of the virtual-image display device.

FIG. 6 is a perspective view and a rear view used to describe a state of a light beam in the imaging system.

FIG. 7 is a conceptual perspective view illustrating a function of a polarized-light diffraction lens.

FIG. 8 is a chart used to describe an operation of the virtual-image display device.

FIG. 9 is a side cross-sectional view used to describe a virtual-image display device according to a modification example.

FIG. 10 is a side cross-sectional view used to describe a virtual-image display device according to a second embodiment.

FIG. 11 is a side cross-sectional view used to describe a virtual-image display device according to a third embodiment.

FIG. 12 is a side cross-sectional view used to describe a virtual-image display device according to a modification example.

FIG. 13 is a side cross-sectional view used to describe a virtual-image display device according to a fourth embodiment.

FIG. 14 is a perspective view illustrating the optical unit illustrated in FIG. 13.

FIG. 15 is a side cross-sectional view used to describe a modification example of the virtual-image display device illustrated in FIG. 13.

FIG. 16 is a perspective view illustrating the optical unit illustrated in FIG. 15.

FIG. 17 is a side cross-sectional view used to describe a virtual-image display device according to a fifth embodiment.

FIG. 18 is a perspective view illustrating the optical unit illustrated in FIG. 17.

### DESCRIPTION OF EMBODIMENTS

### First Embodiment

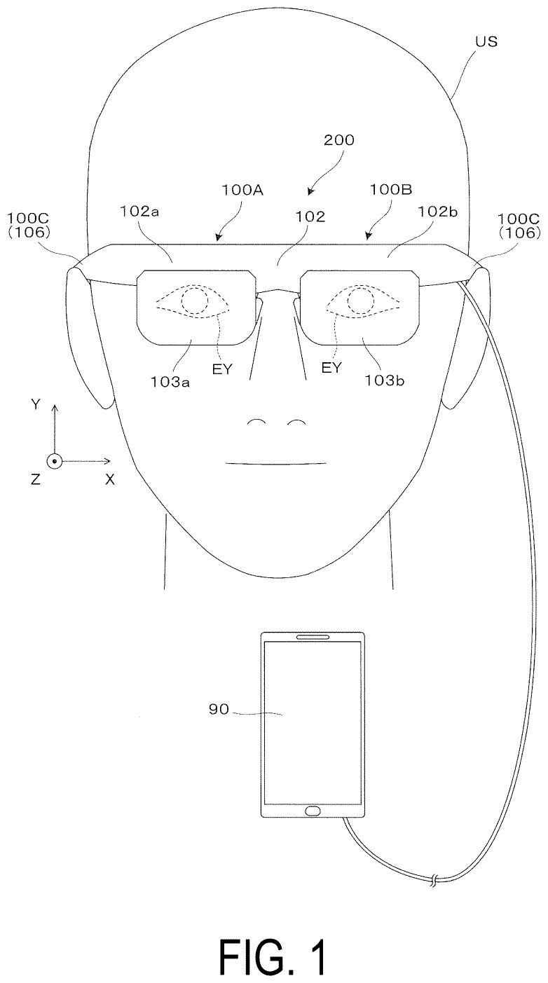

Below, a virtual-image display device according to the first embodiment of the present disclosure will be described with reference to FIGS. 1 to 8.

FIG. 1 is a front view illustrating a state where a head-mounted display, that is, a head-mounted display device 200 is mounted. The head-mounted display device (hereinafter, also referred to as an HMD) 200 allows an observer or a wearer US who wears this device to recognize an image as a virtual image. In FIG. 1 and the like, X, Y, and Z represent a rectangular coordinate system. The +X direction corresponds to a lateral direction in which both eyes EY of the observer or the wearer US, who wears the HMD 200, are arranged. The +Y direction corresponds to the upward direction perpendicular to the lateral direction from the viewpoint of the wearer US in which both the eyes EY are arranged. The +Z direction corresponds to the forward direction or the front side direction from the viewpoint of the wearer US. The +Y direction is parallel to the vertical axis or the vertical direction.

The HMD 200 includes a first virtual-image display device 100A for a right eye, a second virtual-image display device 100B for a left eye, a pair of temples 100C that support the virtual-image display devices 100A and 100B, and a user terminal 90 serving as an information terminal. The first virtual-image display device 100A includes a first display driving unit 102a disposed at an upper portion, and a first display optical system 103a that covers the front of the eye. The second virtual-image display device 100B includes a second display driving unit 102b disposed at an upper portion, and a second display optical system 103b that covers the front of the eye. The HMD 200 in which the first virtual-image display device 100A and the second virtual-image display device 100B are combined together is also a virtual-image display device in a broader sense. The pair of temples 100C function as a mounting member or a supporting device 106 that is worn on the head of the wearer US, and support the upper end sides of the pair of display optical systems 103a and 103b through the display driving units 102a and 102b integrated in exterior. A combination of the pair of display driving units 102a and 102b is referred to as a driving device 102.

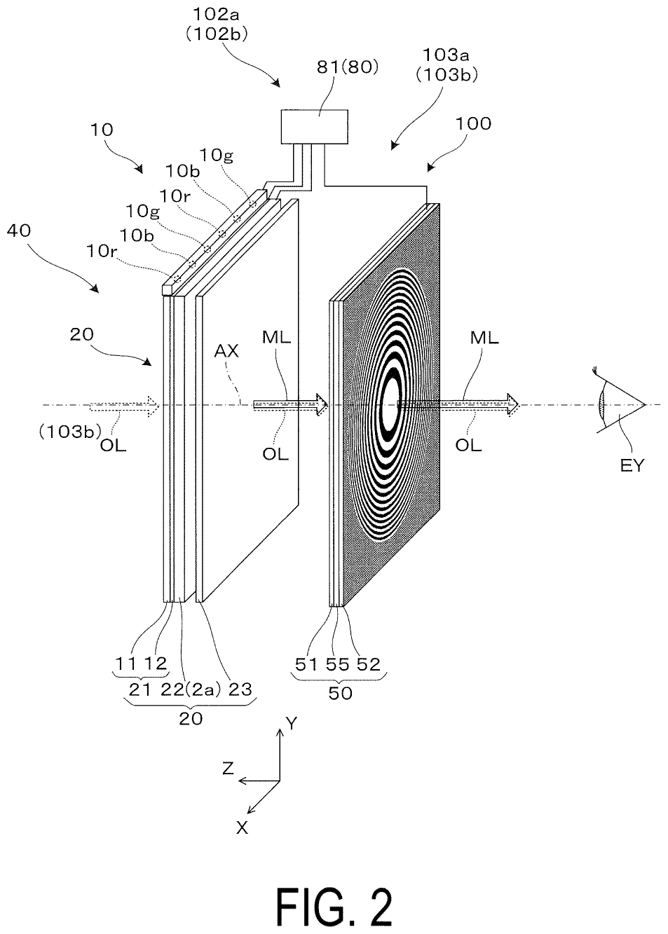

FIG. 2 is a perspective view illustrating the structure of the first display optical system 103a. The first display optical system 103a includes a plate-shaped display section 40 configured to form a two-dimensional image and output image light ML corresponding to the formed image, and also includes a plate-shaped imaging system 50 functioning as a lens for the image light ML outputted from the display section 40 and configured to form a virtual image.

The display section 40 includes a light source 10 configured to generate light of three colors as illumination light in a time-division manner, and also includes a composite display member 20 configured to form the image light ML to output it. The light source 10 also constitutes a portion of the first display driving unit 102a illustrated in FIG. 1, and is disposed at or above the upper side of a light-guiding member 21, which will be described later, of the composite display member 20 so as to supply illumination light from the upper end side to the light-guiding member 21. The display section 40 is driven by a driving circuit 81 of a control device 80 embedded in the first display driving unit 102a or the driving device 102, and operates. The composite display member 20 of the display section 40 is disposed close to the eye EY with the imaging system 50 being interposed between them, which makes it possible achieve observation of the virtual image made of the image light ML and see-through view of the outside world. In the first display optical system 103a, the distance in the optical axis AX direction between the eye EY and the imaging system 50 falls, for example, in a range of approximately 10 mm to 20 mm. In addition, the distance in the optical axis AX direction between the transmissive-type liquid crystal panel 22 of the display section 40 and the polarizing lens 50 falls, for example, in a range of approximately 5 mm to 25 mm.

The light source 10 includes one or a plurality of R light-emitting elements 10r configured to generate light of red, one or a plurality of B light-emitting elements 10b configured to generate light of blue, and one or a plurality of G light-emitting elements 10g configured to generate light of green. The R light-emitting element 10r, the B light-emitting element 10b, and the G light-emitting element 10g are self-light emitting elements that are, for example, organic light emitting diodes (OLED), and may be light emitting diodes such as a micro light emitting diode (μLED) made of inorganic material. A multiplexer/demultiplexer including a beam splitter used to facilitate diffusion of illumination light can be incorporated between the light source 10 and the light-guiding member 21 of the composite display member 20.

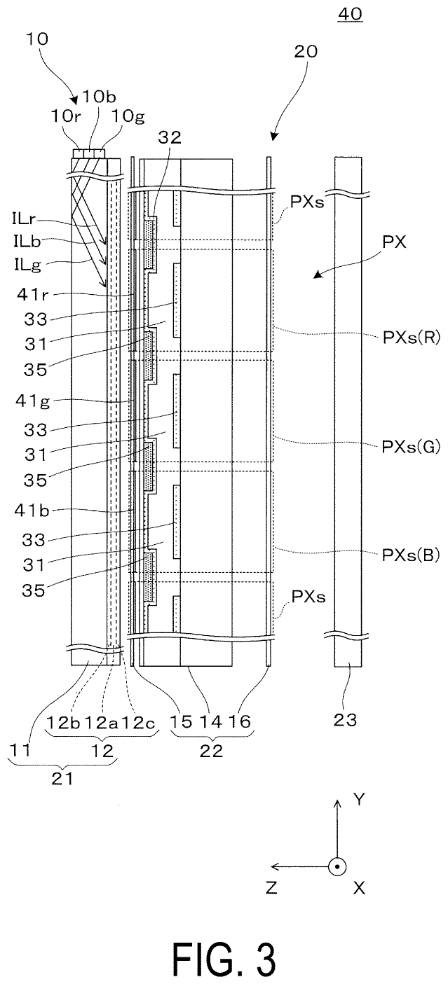

The composite display member 20 is a plate-shape member extending along the XY plane perpendicular to the optical axis AX, and includes the light-guiding member 21, a transmissive-type liquid crystal panel 22, and a quarter wavelength plate 23, in the order from the outside world. The composite display member 20 has a structure in which the light-guiding member 21, the transmissive-type liquid crystal panel 22, and the quarter wavelength plate 23 are stacked to each other, and are integrated by a frame body (not illustrated). Here, the light-guiding member 21 and the transmissive-type liquid crystal panel 22 are disposed close to each other with a predetermined interval or less being provided between them. The transmissive-type liquid crystal panel 22 serves as an imager 2a configured to form image light. Note that the transmissive-type liquid crystal panel 22 includes a plurality of pixels PX (see FIG. 3) arrayed in a matrix manner along the XY plane.

The imaging system 50 is disposed at the side of the face relative to the display section 40 or the composite display member 20, that is, at the −Z side to cover the front of the eye. The imaging system 50 is a plate-shaped member extending along the XY plane. The imaging system 50 includes a first polarized-light diffraction lens 51, a switching half-wave plate 55, and a second polarized-light diffraction lens 52, in the order from the outside world. The composite display member 20 has a structure in which optical elements that constitute the composite display member 20, that is, the first polarized-light diffraction lens 51, the switching half-wave plate 55, and the second polarized-light diffraction lens 52 are disposed close to each other so as to be parallel to each other, and are integrated by a frame body (not illustrated). This integration enables the optical performance of the imaging system 50 to be stabilized, and makes it possible to reduce the thickness of the imaging system 50. Note that, even when, in addition to the switching half-wave plate 55, another optical element is provided between the first polarized-light diffraction lens 51 and the second polarized-light diffraction lens 52, it is possible to integrate them by directly fixing them through a glue material, or to bring them into close contact with each other at their outer peripheries and fix them to integrate them. In addition, before the integration, it is possible to adjust the interval between the first polarized-light diffraction lens 51 and the second polarized-light diffraction lens 52. The imaging system 50 is a dynamical optical element that works differently in accordance with states of the switching half-wave plate 55. The imaging system 50 functions as a lens for the image light ML outputted from the composite display member 20. That is, the imaging system 50 causes a plurality of pixels constituting the transmissive-type liquid crystal panel 22 to be comprehensively imaged, and enables the image formed on the transmissive-type liquid crystal panel 22 to be observed as a virtual image. In addition, the imaging system 50 functions as a parallel flat plate for the external light OL that passes through the composite display member 20. That is, as the external light OL passes through so as to straightly travel through the composite display member 20, the external light is observed as a directly viewed image.

The second display optical system 103b is optically the same as the first display optical system 103a, or is obtained by inverting the first display optical system 103a horizontally. Thus, detailed description thereof will not be given.

Note that an optical device excluding the control device 80 from the first virtual-image display device 100A is referred to as an optical unit 100. Furthermore, an optical device excluding the control device 80 from the second virtual-image display device 100B is referred to as an optical unit 100.

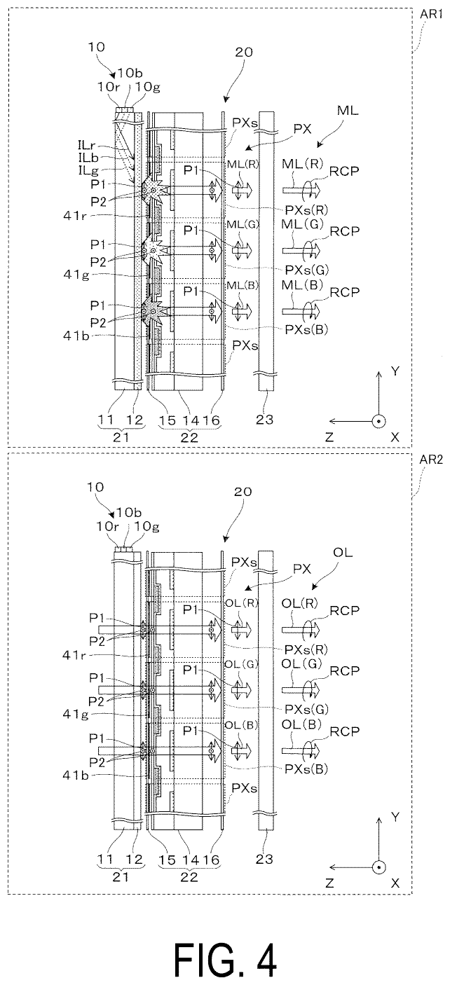

FIG. 3 is an enlarged cross-sectional side view schematically illustrating the structure of the display section 40. FIG. 4 is a diagram used to describe a state of light in the display section 40. In FIG. 4, the first region AR1 illustrates a case where the first display optical system 103a is in an image observation period and the display section 40 is in a displaying state, and the second region AR2 illustrates a case where the first display optical system 103a is in an outside-light observation period and the display section 40 is in a non-displaying state.

With reference to FIG. 3, the light source 10 generates illumination lights ILr, ILg, and ILb of three colors as the illumination light IL, and supplies the illumination lights ILr, ILg, and ILb of three colors to the light-guiding member 21 of the composite display member 20.

The light-guiding member 21 is obtained by fixing a ferroelectric liquid crystal plate 12 to a light-guiding plate 11. The illumination lights ILr, ILg, and ILb from the light source 10 are combined into the light-guiding plate 11 from the upper end of the light-guiding plate 11. The light-guiding plate 11 propagates downward the illumination light ILr, ILg, and ILb entering from the light source 10.

The ferroelectric liquid crystal plate 12 is configured to perform a switching-type operation in accordance with a drive signal from the driving circuit 81, and is able to switch between a scattering state (ON state) where the illumination light IL (ILr, ILg, ILb) is outputted to the outside of the light-guiding plate 11, and a transparent state (OFF state) where the external light OL is caused to pass through and is allowed to pass through. The ferroelectric liquid crystal plate 12 includes a ferroelectric liquid crystal layer 12a interposed between a pair of base members 12b and 12c with a transparent electrode layer (not illustrated) being interposed between them. The ferroelectric liquid crystal layer 12a is, for example, a reverse-mode polymer-dispersed liquid crystal, and turns into a transmitting state when no electric field is applied whereas turning into the scattering state when an electric field is applied (see, for example, JP-A-6-308543 or the like). The ferroelectric liquid crystal plate 12 is able to switch between ON and OFF over the entire surface rather than on a pixel PX basis. Note that the ferroelectric liquid crystal layer 12a may be configured to turn into the transmitting state when an electric field is applied, and turn into the scattering state when no electric field is applied.

The transmissive-type liquid crystal panel 22 includes a liquid-crystal modulation member 14 and a pair of polarizing plates 15 and 16 between which the liquid-crystal modulation member 14 is interposed. In this case, the transmissive-type liquid crystal panel 22 is, for example, a modulation element including an in-plane switching (IPS) type liquid crystal, and specifically includes three types of sub-pixels PXs (R), PXs (G), and PXs (B) as sub-pixels PXs that constitute a pixel PX. These sub-pixels PXs (R), PXs (G), and PXs (B) are arrayed in a stripe pattern or a Bayer pattern to constitute a pixel PX, although illustration is not given. In the sub-pixel PXs (R) for red display, a red color filter 41r is disposed at or around the first polarizing plate 15. In the sub-pixel PXs (G) for green display, a green color filter 41g is disposed at or around the first polarizing plate 15. In the sub-pixel PXs (B) for blue display, a blue color filter 41b is disposed at or around the first polarizing plate 15. The liquid-crystal modulation member 14 does not rotate the polarization direction of the incident light when no electric field is applied, and rotates the polarization direction of the incident light when an electric field is applied. In this case, the pair of polarizing plates 15 and 16 are absorption-type polarizing elements, and are disposed in a direction intersecting the polarization direction, more specifically, in a direction in which the polarization direction is perpendicular. The transmissive-type liquid crystal panel 22 is able to switch ON and OFF on a sub-pixel PXs basis in accordance with a drive signal from the driving circuit 81, and is able to cause incident light to partially pass through with any given gray-scale in the middle of between ON and OFF. For this reason, the liquid-crystal modulation member 14 not only includes a liquid crystal layer 31, a common electrode 32, a pixel electrode 33, and a black matrix 35 but also includes a scanning line, a signal line, a switching element, and the like, although illustration is not given.

Note that the transmissive-type liquid crystal panel 22 or the liquid-crystal modulation member 14 may be configured such that the polarization direction of the incident light is rotated when no electric field is applied, and the polarization direction of the incident light is not rotated when an electric field is applied. In this case, the pair of polarizing plates 15 and 16 are disposed such that polarization directions are parallel to each other.

The quarter wavelength plate 23 includes a main axis in a middle between the X direction and the Y direction, for example, and is configured to convert the image light ML or the external light OL (see FIG. 2) from linear polarized light into circularly polarized light. Here, the “image light ML being circularly polarized light” means that, when attention is paid to oscillation of an electric field or magnetic field of the image light ML, the direction of the oscillation rotates at the frequency of the image light ML within a plane perpendicular to the direction of propagation of the light, and the amplitude thereof remains constant regardless of the direction. The right-handed circularly polarized light is light in which the direction of oscillation of an electric field rotates clockwise as viewed from an observer who stands toward a direction in which the light beam travels, and rotates in a direction opposite to the left-handed circularly polarized light. However, in the present description, when the image light ML mainly contains the right-handed circularly polarized light, such image light ML is assumed to be the right-handed circularly polarized light RCP even if the light contains linear polarization in a specific direction, for example. Similarly, when the image light ML mainly contains the left-handed circularly polarized light, such image light ML is assumed to be the left-handed circularly polarized light LCP. In the present description, the right-handed circularly polarized light RCP is also referred to as right circularly polarized light RCP, and the left-handed circularly polarized light LCP is also referred to as left circularly polarized light LCP.

With reference to FIG. 4, when the display section 40 is in the displaying state during the image observation period, the light-emitting elements 10r, 10g, and 10b of the light source 10 emit light, and the illumination light ILr, ILg, ILb is supplied to the light-guiding member 21. At this timing, when the ferroelectric liquid crystal plate 12 is switched into the ON state to turn into the scattering state, the illumination light ILr, ILg, ILb passes through the first polarizing plate 15 of the transmissive-type liquid crystal panel 22, and illuminates the liquid-crystal modulation member 14 as second polarized light P2 that is lateral polarized light or horizontal polarized light. That is, each of the colorless sub-pixels PXs (R), PXs (G), and PXs (B) that constitute the transmissive-type liquid crystal panel 22 is illuminated. The image light ML (R), ML (G), ML (B) that passes through the liquid-crystal modulation member 14 is light obtained by rotating the polarization surface of the illumination light ILr, ILg, ILb in accordance with a drive signal, and only the first polarized light P1 that passes through the second polarizing plate 16 and is vertical polarized light or perpendicular polarized light is outputted. The image light ML (R), ML (G), ML (B) outputted from each of the sub-pixel PXs of the transmissive-type liquid crystal panel 22 passes through the quarter wavelength plate 23 to be converted from the first polarized light P1 into the right circularly polarized light RCP.

In addition, when the display section 40 is in the non-displaying state during the outside-light observation period, the light source 10 is turned into the non-emitting state, that is, into the turning-off state to stop supply of the illumination light IL to the light-guiding member 21. At this timing, when the ferroelectric liquid crystal plate 12 is switched to the OFF state to turn into the transmitting state, the external light OL (OL (R), OL (G), OL (B)) travels straight so as to intersect the light-guiding member 21, and enters the transmissive-type liquid crystal panel 22. At this time, each of the sub-pixels PXs of the transmissive-type liquid crystal panel 22 operates, for example, in a normally-off state, and is turned into the maximum transmitting state. Of the external light OL that enters each of the sub-pixels PXs (R), PXs (G), and PXs (B) of the transmissive-type liquid crystal panel 22, the second polarized light P2 travels straight through the transmissive-type liquid crystal panel 22, that is, through the pixel PX, and is converted into the first polarized light P1. The external light OL outputted from each of the sub-pixels PXs of the transmissive-type liquid crystal panel 22 passes through the quarter wavelength plate 23, and is converted from the first polarized light P1 into the right circularly polarized light RCP.

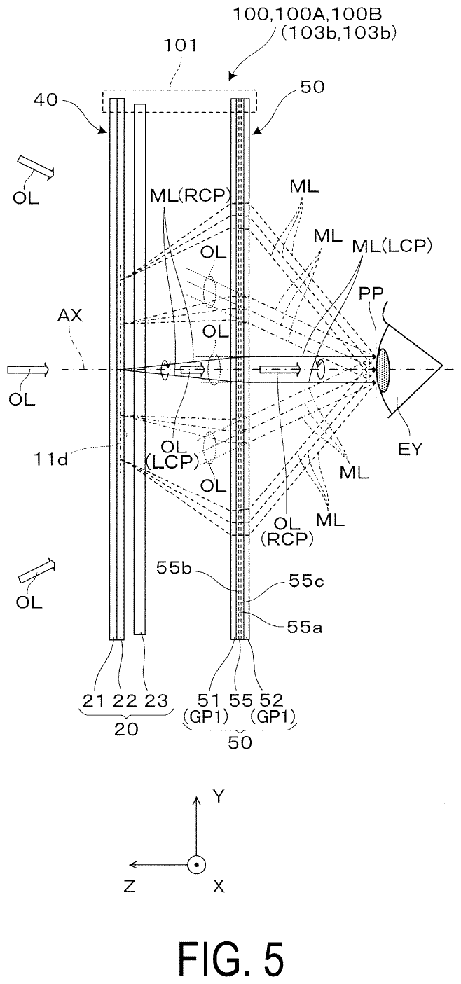

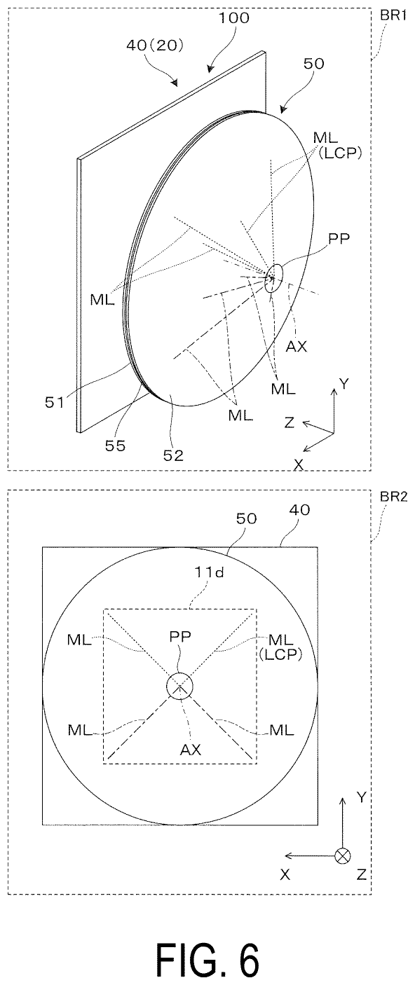

FIG. 5 is a side cross-sectional view illustrating the optical unit 100 of the display optical system 103a, 103b. FIG. 6 is a diagram illustrating the optical unit 100 as viewed from another direction. In FIG. 6, the first region BR1 is a perspective view illustrating the optical unit 100, and the second region BR2 is a rear view illustrating the optical unit 100.

The optical unit 100 includes a display section 40 configured to output the image light ML and cause the external light OL to pass through, and also includes an imaging system 50 functioning as a convex lens or a collimator having a positive power for the image light ML. The optical unit 100 also includes a supporting member 101 configured to relatively fix the display section 40 and the imaging system 50.

In the imaging system 50, when predetermined polarized light enters the first polarized-light diffraction lens 51, the first polarized-light diffraction lens 51 alone functions in a manner like a convex lens. In addition, when predetermined polarized light enters the second polarized-light diffraction lens 52, the second polarized-light diffraction lens 52 alone also functions in a manner like a convex lens. The switching half-wave plate 55 is able to switch between the ON state and the OFF state. When the half-wave plate 55 is in the ON state, both the polarized-light diffraction lenses 51 and 52 are caused to function as a convex lens. When the switching half-wave plate 55 is in the OFF state, powers of the polarized-light diffraction lenses 51 and 52 are cancelled to cause them to function as a parallel flat plate glass.

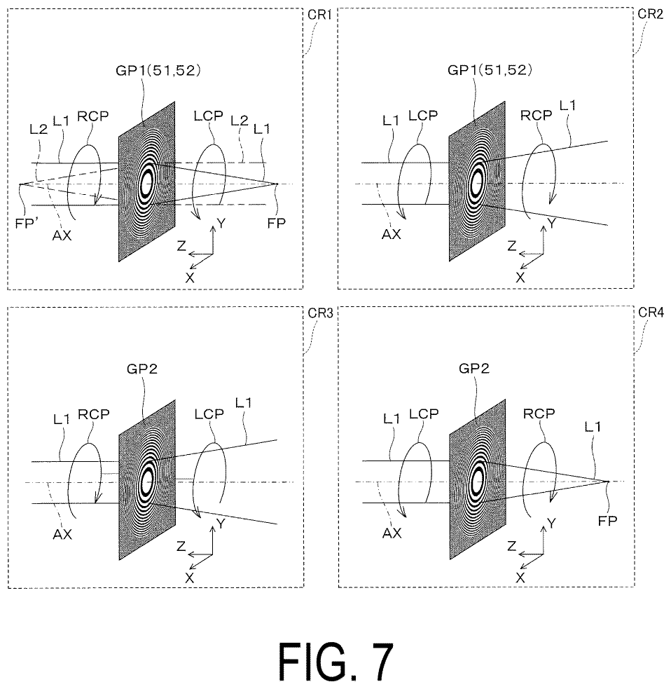

FIG. 7 is a diagram used to describe the functions of the first polarized-light diffraction lens 51 and the second polarized-light diffraction lens 52. In FIG. 7, the first region CR1 illustrates a first operation example of a polarized-light diffraction lens GP1 of a first type, and the second region CR2 illustrates a second operation example of the polarized-light diffraction lens GP1 of the first type. In FIG. 7, the third region CR3 illustrates a first operation example of a polarized-light diffraction lens GP2 of a second type, and the fourth region CR4 illustrates a second operation example of the polarized-light diffraction lens GP2 of the second type. The first polarized-light diffraction lens 51 and the second polarized-light diffraction lens 52 illustrated in FIG. 5 are the polarized-light diffraction lens GP1 of the first type.

When the right circularly polarized light RCP collimated in a manner like the light beam L1 illustrated by the solid line enters the polarized-light diffraction lens GP1 from the left side in the drawing, the polarized-light diffraction lens GP1 has a function of converting the right circularly polarized light RCP into the left circularly polarized light LCP and causing the light to converge to be collected to the focal point FP. When the left circularly polarized light LCP collimated in a manner like the light beam L1 illustrated by the solid line enters the polarized-light diffraction lens GP1 from the left side in the drawing, the polarized-light diffraction lens GP1 has a function of converting the left circularly polarized light LCP into the right circularly polarized light RCP and causing the light to diverge. Note that, when the right circularly polarized light RCP that diverges from the focal point FP′ at the left side of the drawing as with the light beam L2 illustrated by the long dashed double-short dashed line enters the polarized-light diffraction lens GP1, the polarized-light diffraction lens GP1 has a function of converting the right circularly polarized light RCP into the left circularly polarized light LCP and collimating the light. That is, the polarized-light diffraction lens GP1 functions in a manner similar to a convex lens having a predetermined focal length relative to the right circularly polarized light RCP, and also reverses the rotational direction of the polarized light. In addition, the polarized-light diffraction lens GP1 functions in a manner similar to a concave lens having a focal length having the same absolute value relative to the left circularly polarized light LCP, and also reverses the rotational direction of the polarized light. That is, the polarized-light diffraction lens GP1 is an optical element having a positive power for the right circularly polarized light RCP and also having a negative power for the left circularly polarized light LCP.

When the right circularly polarized light RCP collimated in a manner similar to the light beam L1 illustrated by the solid line enters the polarized-light diffraction lens GP2 from the left side in the drawing, the polarized-light diffraction lens GP2 has a function of converting the right circularly polarized light RCP into the left circularly polarized light LCP and causing the light to diverge. When the left circularly polarized light LCP collimated in a manner similar to the light beam L1 illustrated by the solid line enters the polarized-light diffraction lens GP2 from the left side in the drawing, the polarized-light diffraction lens GP2 has a function of converting the left circularly polarized light LCP into the right circularly polarized light RCP, and causing the light to converge to be collected to the focal point FP. That is, the polarized-light diffraction lens GP2 functions in a manner similar to a convex lens having a predetermined focal length relative to the left circularly polarized light LCP, and also reverses the rotational direction of the polarized light. In addition, the polarized-light diffraction lens GP2 functions in a manner similar to a concave lens having a focal length having the same absolute value relative to the right circularly polarized light RCP, and also reverses the rotational direction of the polarized light. That is, the polarized-light diffraction lens GP2 is an optical element having a negative power for the right circularly polarized light RCP and also having a positive power for the left circularly polarized light LCP.

The polarized-light diffraction lens GP1, GP2 includes distribution of refractive-index anisotropy formed in a flat surface and made of a large number of ring-shaped band units with the optical axis AX being the center, and functions as a diffraction lens in accordance with this distribution of the refractive-index anisotropy and the polarization state of the incident light. Specifically, when the polarized-light diffraction lens GP1, GP2 includes the distribution of refractive-index anisotropy configured such that the orientation of the optical axis more rotates (actually, repeats in a range of 0 to π) with distance from the optical axis AX with respect to two directions perpendicular to the optical axis AX that is the center, geometric phases are formed in specific circularly polarized light that enters this lens. The circularly polarized light is diffracted at an angle of diffraction corresponding to the cycle length of the rotation of the optical axis with respect to each of the orientations, and the polarization state is inverted. The polarized-light diffraction lens as a whole causes specific circularly polarized light to be diffracted so as to correspond to the power formed by the shape of the lens, and inverts the state of the circularly polarized light, for example, from the right circularly polarized light to the left circularly polarized light before and after passage of the light.

Although illustration is not given, the polarized-light diffraction lens GP1 and the polarized-light diffraction lens GP2 are obtained by forming, on a transparent substrate, a thin-membrane layer containing a material containing liquid crystal, and have a thin plate shape as a whole. The layer containing a material containing liquid crystal includes a predetermined liquid crystal material, and is configured such that alignment axes of liquid crystal molecules are aligned parallel, for example, to the X direction at a nearby region of the optical axis AX so as to form a predetermined geometric phase, and gradually rotate in the XY plane with distance from the optical axis AX, that is, in accordance with the distance or the radius with the optical axis AX being the center. That is, the angle of rotation of the alignment axes of the liquid crystal molecules increases in accordance with the distance from the optical axis AX, and these are regularly repeated. In a liquid-crystal compound layer, the alignment axes of the liquid crystal molecules are arrayed at regular intervals with respect to the Z direction parallel to the optical axis AX, for example. Note that the polarized-light diffraction lens GP1 and the polarized-light diffraction lens GP2 are inverted in terms of a direction in which the angle of rotation of alignment axes of the liquid crystal molecules is increased. For example, the method of manufacturing the polarized-light diffraction lens GP1 or the polarized-light diffraction lens GP2 is configured such that a material film containing liquid crystal in which a liquid crystal material and an organic-material layer of a ultraviolet-light curable type are mixed together is applied on a substrate, and UV laser light in a predetermined polarization state is two-dimensionally scanned over the material layer containing liquid crystal, thereby curing the organic-material layer while adjusting the alignment axes of the liquid crystal molecules. With this method, it is possible to three-dimensionally control the alignment axes of the liquid crystal molecules within the material layer containing liquid crystal to fix them. This makes it possible to obtain a liquid-crystal compound layer in which the angle of rotation of the alignment axes increases with distance from the optical axis AX as described above. Such a polarized-light diffraction lens GP1 itself is a known technique (see, for example, a reference “Kohei Noda, et al. Applied Optics, Feb. 10 2017, Vol.56, No.5:1302) as a Fresnel lens having polarization dependency, for example.

The polarized-light diffraction lens GP1 and the polarized-light diffraction lens GP2 are not necessary to be separate items. The polarized-light diffraction lens GP2 can be obtained by rotating the polarized-light diffraction lens GP1 by 180° around the Y-axis, and turning it inside out. That is, by swapping the inside and the outside of the polarized-light diffraction lens GP1, GP2, it is possible to cause the polarized-light diffraction lens GP1, GP2 to function as a convex lens and a concave lens for the same circularly polarized light. The reason for this is that, in the polarized-light diffraction lenses GP1 and GP2, since the alignment axes of liquid crystal molecules are increased in accordance with the distance from the optical axis AX so as to rotate in a specific direction as described above, the rotational direction in terms of the absolute value of the distance matches each other with respect to, for example, the ±X direction perpendicular to the optical axis AX, and the rotational directions of the alignment axes are inverted when the individual polarized-light diffraction lenses GP1 and GP2 are viewed from the rear side.

The focal length of the polarized-light diffraction lens GP1 and the focal length of the polarized-light diffraction lens GP2 can be changed so as to increase or decrease depending on the manufacturing method or the liquid crystal material. In the liquid-crystal compound layer, for example, by increasing the rate of increase in the angle of rotation of the alignment axis of the liquid crystal molecule in accordance with the distance from the optical axis AX or the radius, that is, reducing the cycle length of rotation of the alignment axis at the time of increasing the angle of rotation of the alignment axis of liquid crystal molecule with the distance from the optical axis AX, it is possible to increase the absolute value of the positive or negative power of the polarized-light diffraction lens GP1, GP2, thereby making it possible to adjust the focal length. The loss of the light beam L1 of circularly polarized light is almost zero when the light passes through the polarized-light diffraction lens GP1, GP2, and the polarized-light diffraction lens GP1, GP2 exhibits almost 100% of transmittance.

When linear polarized light enters the polarized-light diffraction lens GP1, behavior differs depending on the right circularly polarized light RCP and the left circularly polarized light LCP contained in the linear polarized light. The component of the right circularly polarized light RCP is collected through the polarized-light diffraction lens GP1. The component of the left circularly polarized light LCP diverges through the polarized-light diffraction lens GP1, and the rotational direction of each of the polarized lights is inverted.

Returning to FIG. 5, the switching half-wave plate 55 is a device configured to perform a switching-type operation in accordance with a drive signal from the driving circuit 81. The switching half-wave plate 55 switches the polarization state of the incident light from the right circularly polarized light RCP into the left circularly polarized light LCP on the basis of the alignment direction of the liquid crystal to cause it to pass through, or causes the right circularly polarized light RCP to directly pass through as it is. That is, the switching half-wave plate 55 switches into an ON state and an OFF state. The ON state serves as a first state where the image light ML that has passed through the first polarized-light diffraction lens 51 is returned from the left circularly polarized light LCP that is second circularly polarized light into the right circularly polarized light RCP that is first circularly polarized light. The OFF state serves as a second state where the image light ML that has passed through the first polarized-light diffraction lens 51 is caused to directly pass in a state of the left circularly polarized light LCP that is the second circularly polarized light as it is. The switching half-wave plate 55 includes a liquid crystal layer 55a interposed between a pair of base members 55b and 55c with a transparent electrode layer (not illustrated) being interposed between them. The liquid crystal layer 55a is, for example, an in-plane switching (IPS) liquid crystal or the like. When an electrical field is applied, the liquid crystal layer 55a causes the switching half-wave plate 55 to function as an optical element equivalent to a half-wave plate having a main axis or fast axis set at a specific direction (for example, intermediate direction between the X direction and the Y direction). When no electrical field is applied, the liquid crystal layer 55a causes the switching half-wave plate 55 to function as an isotropic parallel flat plate. The switching half-wave plate 55 switches between the ON state and the OFF state for the entire surface thereof, rather than on a pixel basis.

In the imaging system 50, when the first polarized-light diffraction lens 51 is the polarized-light diffraction lens GP1 illustrated in FIG. 7, and the image light ML entering from the display section 40 or the external light OL is the right circularly polarized light RCP, the first polarized-light diffraction lens 51 functions as an optical element having a positive power for the image light ML or the external light OL, and inverts the rotational direction of the polarized light into the left circularly polarized light LCP while reducing the degree of divergence of the image light ML or the external light OL. The image light ML or the external light OL that has passed through the first polarized-light diffraction lens 51 enters the switching half-wave plate 55 in a state of the left circularly polarized light LCP.

During the image observation period, that is, at the timing when the image light ML enters, the switching half-wave plate 55 is in the ON state. In addition, during the outside-light observation period, that is, at the timing when the external light OL enters, the switching half-wave plate 55 is in the OFF state.

During the image observation period, the switching half-wave plate 55 that is in the ON state converts the image light ML that enters the switching half-wave plate 55 from the left circularly polarized light LCP into the right circularly polarized light RCP. However, as with a parallel flat plate, the switching half-wave plate 55 substantially does not impart the converging effects, and allows the image light ML to pass through to enter the second polarized-light diffraction lens 52. When the second polarized-light diffraction lens 52 is the polarized-light diffraction lens GP1 illustrated in FIG. 7, and the image light ML that has passed through the switching half-wave plate 55 is the right circularly polarized light RCP, the second polarized-light diffraction lens 52 functions as an optical element having a positive power for the image light ML, and inverts the rotational direction of the polarized light into the left circularly polarized light LCP while reducing the degree of divergence of the image light ML. At this time, the absolute value of the power of the first polarized-light diffraction lens 51 and the absolute value of the power of the second polarized-light diffraction lens 52 are set so as to be equal to each other, and the combined focal length of both of the polarized-light diffraction lenses 51 and 52 is substantially equivalent to the combined focal length of two thin-type convex lenses disposed adjacent to each other. When the combined focal length of both of the polarized-light diffraction lenses 51 and 52 is equal to the distance from the middle point between both of the polarized-light diffraction lenses 51 and 52 to the display surface 11d of the display section 40, the imaging system 50 functions as a collimator, and collects the image light ML to the pupil position PP while collimating the image light ML. FIG. 6 only illustrates the main beam of the image light ML from the display surface 11d. It is understood that the image light ML from the diagonal position of the display surface 11d passes through the pupil position PP.

In addition, during the outside-light observation period, the switching half-wave plate 55 in the OFF state maintains the external light OL entering the switching half-wave plate 55 to be the left circularly polarized light LCP, and causes the light to enter the second polarized-light diffraction lens 52. When the second polarized-light diffraction lens 52 is the polarized-light diffraction lens GP1 illustrated in FIG. 7, and the external light OL that has passed through the switching half-wave plate 55 is the left circularly polarized light LCP, the second polarized-light diffraction lens 52 functions as an optical element having a negative power for the external light OL, and inverts the rotational direction of the polarized light into the right circularly polarized light RCP while reducing the degree of convergence of the external light OL. At this time, both of the polarized-light diffraction lenses 51 and 52 are disposed close to each other and the absolute values of the powers of these lenses are set so as to be equal to each other. In addition, the combined focal length of both of the polarized-light diffraction lenses 51 and 52 is infinite distance. When the combined focal length of the polarized-light diffraction lenses 51 and 52 is the infinite distance, the imaging system 50 functions as a system equivalent to a parallel flat plate that is an optical system having a power of substantially zero, and does not exert any image formation operation such as collection of light on the external light OL to allow the light to travel substantially straight, whereby it is possible to achieve a state where the external light OL is observed using a naked eye.

In this manner, during the image observation period, the imaging system 50 is turned into the state of having a positive power by the switching half-wave plate 55 in the ON state, which makes it possible to observe the image light ML. In addition, during the outside-light observation period, the imaging system 50 is turned into the state where the power is substantially zero by the switching half-wave plate 55 in the OFF state, which makes it possible to observe the external light OL. That is, the virtual-image display devices 100A and 100B or the display optical systems 103a and 103b make it possible to perform see-through display in which the image light ML and the external light OL are superimposed in a time-division manner.

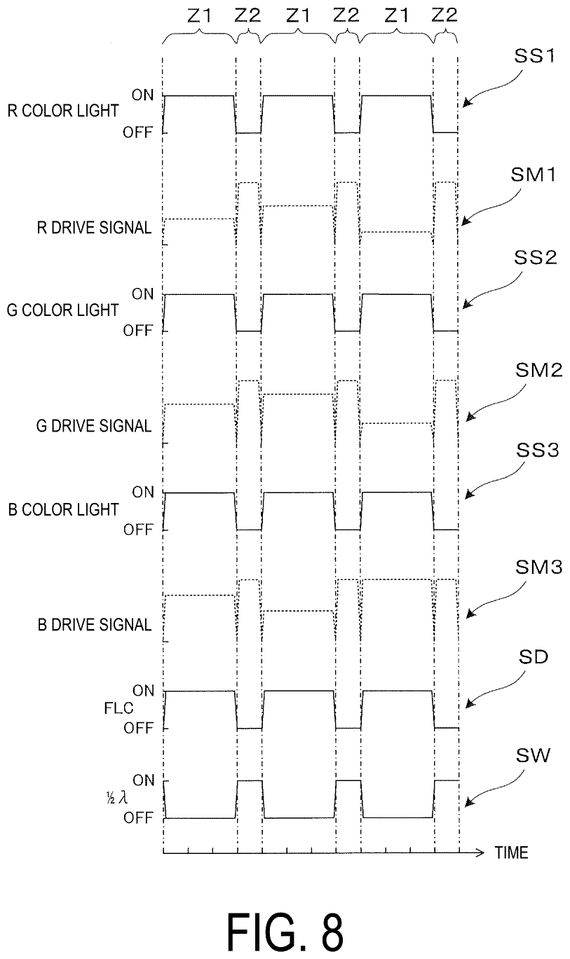

FIG. 8 is a timing chart used to describe a display operation by the display optical systems 103a and 103b. The horizontal axis indicates time. In addition, the chart indicates, from the upper side: a blinking signal SS1 of the R light-emitting element 10r; an R drive signal SM1 for red display supplied to the liquid-crystal modulation member 14; a blinking signal SS2 of the G light-emitting element 10g; a G drive signal SM2 for green display supplied to the liquid-crystal modulation member 14; a blinking signal SS3 of the B light-emitting element 10b; a B drive signal SM3 for blue display supplied to the liquid-crystal modulation member 14; an on-off signal SD of a ferroelectric liquid crystal plate (FLC) 12; and an on-off signal SW of a switching half-wave plate (1/2λ) 55. As for operations by the first virtual-image display device 100A, each frame includes a first sub-frame Z1 serving as a sub-frame for observing an image, and a second sub-frame Z2 serving as a sub-frame for observing the outside light.

In this case, when the first virtual-image display device 100A is in the image observation period and the transmissive-type liquid crystal panel 22 is in the displaying state, the image lights ML (R), ML (G), and ML (B) of three colors are displayed in parallel at the same time. When the first virtual-image display device 100A is in the outside-light observation period and the transmissive-type liquid crystal panel 22 is in the non-displaying state, the external light OL passes through the sub-pixels PXs (R), PXs (G), and PXs (B) of the transmissive-type liquid crystal panel 22 in a well-balanced manner. Thus, it is possible to observe the outside-world image to which no color is added.

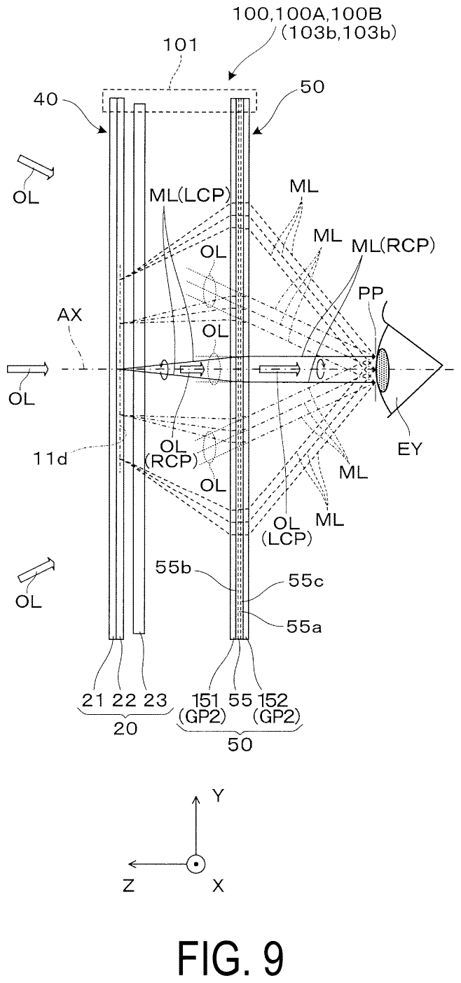

FIG. 9 is a diagram used to describe the first display optical systems 103a and 103b according to a modification example, and corresponds to FIG. 5. In this case, in the early stage of the time division, the image light ML of the left circularly polarized light LCP is caused to be outputted from the display section 40, and in the latter stage of the time division, the external light OL of the left circularly polarized light LCP is caused to pass through by the display section 40.

In the imaging system 50, when a first polarized-light diffraction lens 151 and a second polarized-light diffraction lens 152 are the polarized-light diffraction lens GP2 illustrated in FIG. 7 and the image light ML and the external light OL entering from the display section 40 are the left circularly polarized light LCP, the first polarized-light diffraction lens 151 and the second polarized-light diffraction lens 152 function as an optical element having a positive power for the image light ML and the external light OL, and invert the rotational direction of the polarized light into the right circularly polarized light RCP while reducing the degree of divergence of the image light ML or the external light OL.

During the image observation period, the image light ML that has passed through the first polarized-light diffraction lens 151 enters the switching half-wave plate 55 to be returned to the left circularly polarized light LCP, and enters the second polarized-light diffraction lens 152. Thus, the first polarized-light diffraction lens 151 and the second polarized-light diffraction lens 152 cause the image light ML that passes through from the display section 40 side to relatively converge, and at the same time, turn the left circularly polarized light LCP that is the first circularly polarized light into the right circularly polarized light RCP that is the second circularly polarized light. In this case, the imaging system 50 is in a state of having a positive power, and hence, it is possible to observe the image light ML.

In addition, during the outside-light observation period, the external light OL that has passed through the first polarized-light diffraction lens 151 enters the switching half-wave plate 55 to be maintained to be the right circularly polarized light RCP, and enters the second polarized-light diffraction lens 152. Thus, the first polarized-light diffraction lens 151 and the second polarized-light diffraction lens 152 cause the external light OL passing through from the display section 40 side to travel substantially straight, and maintain the light to be the left circularly polarized light LCP that is the first circularly polarized light as it is. In this case, the imaging system 50 is in a state of not having a power, and it is possible to observe the external light OL.

In the description above, an item in which the transmissive-type liquid crystal panel 22 is embedded is used as the display section 40. However, in place of the transmissive-type liquid crystal panel 22, it is possible to use other types of imager 2a such as an organic electro-luminescence (organic EL) display. However, it is desirable that the organic EL display imager 2a be configured to block the external light OL during the time when an image is displayed, and allow the external light OL to pass through during the time when displaying the image is stopped. In this case, it is desirable to dispose a polarizing plate 16 (see FIG. 3) serving as the imager 2a at a side of the organic EL display from which light is outputted.

In the description above, the transmissive-type liquid crystal panel 22 includes the sub-pixels PXs (R), PXs (G), and PXs (B) of three colors. However, when the color aberration of the imaging system 50 is large, it may be possible to employ a configuration in which the imager 2a or the transmissive-type liquid crystal panel 22 only includes a single-color pixel. Note that, when the lateral color aberration of the imaging system 50 is large, it may be possible to adjust a multiplication factor or the like of an image formed at the sub-pixel PXs (R), PXs (G), PXs (B) to cancel the lateral color aberration.

The virtual-image display device according to the first embodiment 100A and 100B or the optical unit 100 described above includes: the display section 40 configured to output the image light ML; the first polarized-light diffraction lens 51 disposed so as to be opposed to the display section 40 and having a positive power for the image light ML of circularly polarized light; and the second polarized-light diffraction lens 52 disposed so as to be opposed to the display section 40 with the first polarized-light diffraction lens 51 being interposed between the second polarized-light diffraction lens 52 and the display section 40, the second polarized-light diffraction lens 52 having a positive power for the image light ML of circularly polarized light that passes through the first polarized-light diffraction lens 51.

In the virtual-image display devices 100A and 100B described above, the first polarized-light diffraction lens 51 has a positive power for the image light ML of circularly polarized light from the display section 40, and the second polarized-light diffraction lens 52 has a positive power for the image light ML of circularly polarized light that passes through the first polarized-light diffraction lens 51. Thus, even when the display section 40 is disposed in front of the eye, it is possible to observe an image formed on the display surface 11d of the display section 40 by using the thin imaging system 50 including the pair of polarized-light diffraction lenses 51 and 52 and having a short focal length. That is, it is possible to reduce the thickness of the virtual-image display devices 100A and 100B including the imaging system 50.

The virtual-image display devices 100A and 100B according to the present embodiment further includes the switching half-wave plate 55 disposed between the first polarized-light diffraction lens 51 and the second polarized-light diffraction lens 52. The switching half-wave plate 55 is configured such that the image light ML passing through the first polarized-light diffraction lens 51 and turned from the right circularly polarized light RCP that is the first circularly polarized light into the left circularly polarized light LCP that is the second circularly polarized light is returned to the first circularly polarized light, that is, to the right circularly polarized light RCP. This switching half-wave plate 55 switches between an ON state and an OFF state. The ON state serves as the first state where the image light ML that has passed through the first polarized-light diffraction lens 51 is returned from the left circularly polarized light LCP that is the second circularly polarized light into the right circularly polarized light RCP that is the first circularly polarized light. The OFF state serves as the second state where the image light ML that has passed through the first polarized-light diffraction lens 51 is caused to directly pass in a state of the left circularly polarized light LCP that is the second circularly polarized light as it is. In addition, when the switching half-wave plate is in the first state, the display section 40 outputs the image light ML that is the first circularly polarized light, and when the switching half-wave plate 55 is in the second state, the display section 40 causes the external light OL to pass through. In this case, when the switching half-wave plate 55 is in the first state, it is possible to observe, as a virtual image, an image formed on the display surface 11d of the display section 40 through a lens effect of the polarized-light diffraction lenses 51 and 52. In addition, when the switching half-wave plate 55 is in the second state, it is possible to directly observe the outside world through a flat-plate effect of the polarized-light diffraction lenses 51 and 52. Such virtual-image display devices 100A and 100B make it possible to perform see-through display in which the image light ML and the external light OL are superimposed.

### Second Embodiment

Below, a virtual-image display device according to a second embodiment or the like will be described. Note that the virtual-image display device according to the second embodiment is obtained by partially modifying the virtual-image display device according to the first embodiment, and explanation of portions common to the virtual-image display device according to the first embodiment will not be repeated.

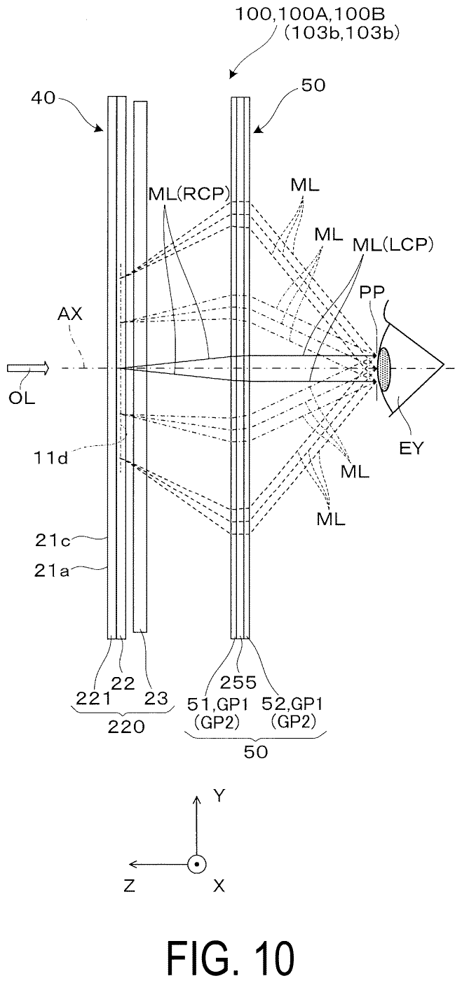

In the virtual-image display devices 100A and 100B or the optical unit 100 illustrated in FIG. 10, a light-guiding member 221 of an outside-light blocking type is embedded in a composite display member 220 of the display section 40. The light-guiding member 221 is configured such that a light shielding film 21c is formed at an outer-side surface 21a of the member, and the transmissive-type liquid crystal panel 22 does not perform an operation of causing the external light OL to pass through. That is, in FIG. 8, the second sub-frame Z2 serving as the sub-frame for outside-light observation is not provided. Thus, only the image light ML enters the imaging system 50.

In the imaging system 50, a non-dynamic half-wave plate 255 of which state is kept unchanged is disposed in place of the switching half-wave plate 55 illustrated in FIG. 5, and the image light ML that passes through the first polarized-light diffraction lens 51 to be turned into the left circularly polarized light LCP is converted into the right circularly polarized light RCP. Note that the first polarized-light diffraction lens 51 and the second polarized-light diffraction lens 52 are the polarized-light diffraction lens GP1.

In the present embodiment, the display section 40 does not cause the external light OL to pass through, and the virtual-image display devices 100A and 100B do not perform see-through display. Only a virtual image formed by the display section 40 is displayed.

In the imaging system 50, the polarized-light diffraction lens GP2 illustrated in FIG. 7 can be used as the first polarized-light diffraction lens 51 and the second polarized-light diffraction lens 52. In this case, the polarization state of the image light ML is inverted from that illustrated in FIG. 10. However, it is possible to cause the image light ML of the collimated right circularly polarized light RCP to enter the pupil position PP.

In the virtual-image display devices 100A and 100B according to the present embodiment, the half-wave plate 255 is disposed between the first polarized-light diffraction lens 51 and the second polarized-light diffraction lens 52, and is configured such that the image light ML passing through the first polarized-light diffraction lens 51 and turned from the right circularly polarized light RCP that is the first circularly polarized light to the left circularly polarized light LCP that is the second circularly polarized light is returned to the first circularly polarized light, that is, to the right circularly polarized light RCP. In this case, with the half-wave plate 255, it is possible to cause the first circularly polarized light, that is, the right circularly polarized light RCP to enter the second polarized-light diffraction lens 52. Thus, on the assumption that the first polarized-light diffraction lens 51 and the second polarized-light diffraction lens 52 are of the same type that exhibits a similar power property for the right circularly polarized light RCP, it is possible to cause these lenses to function as a convex lens even if they have a plate shape.

### Third Embodiment

Below, a virtual-image display device according to a third embodiment or the like will be described. Note that the virtual-image display device according to the third embodiment is obtained by partially modifying the virtual-image display device according to the first embodiment, and explanation of portions common to the virtual-image display device according to the first embodiment will not be repeated.

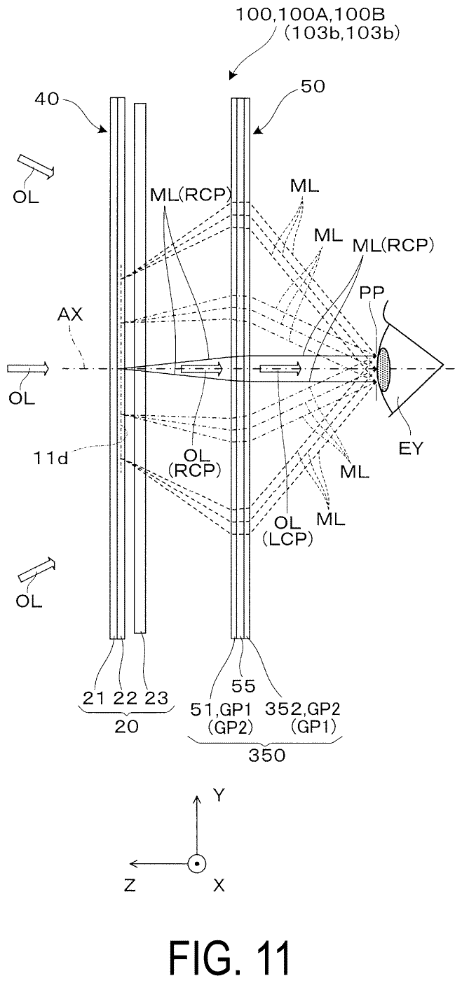

In the virtual-image display devices 100A and 100B or the optical unit 100 illustrated in FIG. 11, the imaging system 50 includes the first polarized-light diffraction lens 51, a second polarized-light diffraction lens 352, and the switching half-wave plate 55. The polarized-light diffraction lens GP1 illustrated in FIG. 7 is used as the first polarized-light diffraction lens 51. The polarized-light diffraction lens GP2 illustrated in FIG. 7 is used as the second polarized-light diffraction lens 352.

In the imaging system 50, when the image light ML or the external light OL entering from the display section 40 is the right circularly polarized light RCP, the first polarized-light diffraction lens 51 functions as an optical element having a positive power for the image light ML and the external light OL, and inverts the rotational direction of the polarized light to turn the light into the left circularly polarized light LCP. When the image light ML or the external light OL that enters is the right circularly polarized light RCP, the second polarized-light diffraction lens 352 functions as an optical element having a positive power for the image light ML and the external light OL, and inverts the rotational direction of the polarized light to turn the light into the left circularly polarized light LCP.

During the image observation period, the image light ML that has passed through the first polarized-light diffraction lens 51 enters the switching half-wave plate 55 in the OFF state, and is maintained to be the left circularly polarized light LCP, and enters the second polarized-light diffraction lens 352. The second polarized-light diffraction lens 352 functions as an optical element having a positive power for the image light ML of the left circularly polarized light LCP that has passed through the switching half-wave plate 55, and inverts the rotational direction of the polarized light to turn the light into the right circularly polarized light RCP while imparting the converging effect to the image light ML. That is, the imaging system 50 as a whole uses the positive power to impart the converging effect to the image light ML that passes through from the display section 40 side, and at the same time, maintains the right circularly polarized light RCP that is the first circularly polarized light to be the right circularly polarized light RCP that is the first circularly polarized light as it is. In this case, imaging system 50 is in a state of having a positive power, which makes it possible to observe the image light ML.

During the outside-light observation period, the external light OL that has passed through the first polarized-light diffraction lens 51 enters the switching half-wave plate 55 in the ON state to be converted from the left circularly polarized light LCP into the right circularly polarized light RCP, and enters the second polarized-light diffraction lens 352. The second polarized-light diffraction lens 352 functions as an optical element having a negative power for the image light ML of the right circularly polarized light RCP that has passed through the switching half-wave plate 55. That is, the first polarized-light diffraction lens 51 uses the positive power to impart the converging effect to the external light OL that passes through the display section 40 side, and at the same time, convers the light from the right circularly polarized light RCP that is the first circularly polarized light into the left circularly polarized light LCP that is the second circularly polarized light. In addition, the second polarized-light diffraction lens 352 cancels, by the negative power, the convergence of the external light OL that has been outputted from the first polarized-light diffraction lens 51 and passed through the switching half-wave plate 55 to be returned to the right circularly polarized light RCP, and at the same time, converts the light from the right circularly polarized light RCP that is the first circularly polarized light into the left circularly polarized light LCP that is the second circularly polarized light. That is, the imaging system 50 does not exert any image formation operation such as collection of light on the external light OL, and allows the light to travel substantially straight, whereby it is possible to achieve a state where the external light OL is observed using a naked eye.

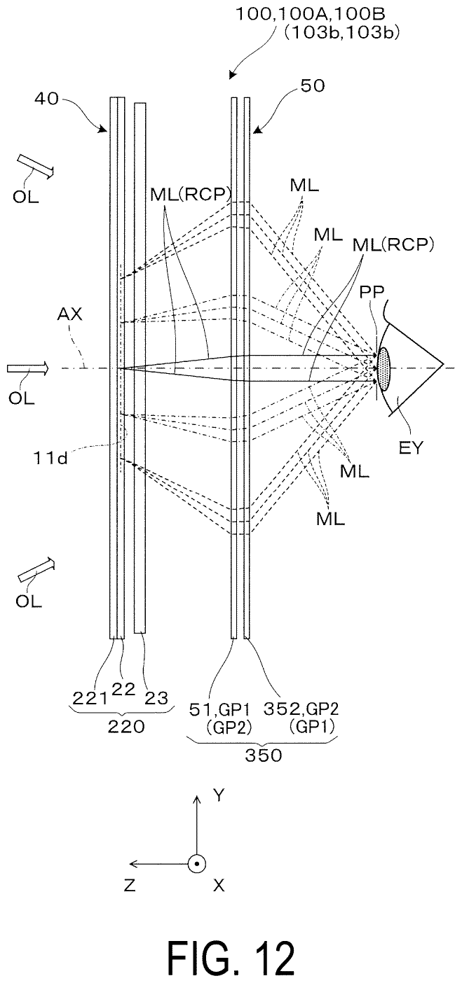

FIG. 12 is a diagram used to describe virtual-image display devices 100A and 100B according to a modification example. In this case, in the display section 40 illustrated in the drawing, the light-guiding member 221 of an outside-light blocking type is embedded in the composite display member 220, as in FIG. 10. In addition, the switching half-wave plate 55 illustrated in FIG. 5 is not provided in the imaging system 50. Here, the imaging system 50 includes the polarized-light diffraction lens GP1 serving as the first polarized-light diffraction lens 51, and also includes the polarized-light diffraction lens GP2 serving as the second polarized-light diffraction lens 352. However, when the image light ML of the left circularly polarized light LCP is caused to be outputted from the display section 40, the first polarized-light diffraction lens 51 is set as the polarized-light diffraction lens GP2, and the second polarized-light diffraction lens 352 is set as the polarized-light diffraction lens GP1.

In the present embodiment, the display section 40 does not allow the external light OL to pass through. Thus, the virtual-image display devices 100A and 100B do not perform see-through display, and only display a virtual image formed by the display section 40.

In a case of the present embodiment, the imaging system 50 does not include any half-wave plate, and only includes the polarized-light diffraction lens 51, 352. Here, the distance between the first polarized-light diffraction lens 51 and the second polarized-light diffraction lens 352 can be adjusted, and it is possible to bring them into close contact with each other.

### Fourth Embodiment

Below, a virtual-image display device according to a fourth embodiment or the like will be described. Note that the virtual-image display device according to the fourth embodiment is obtained by partially modifying the virtual-image display device according to the second embodiment, and explanation of portions common to the virtual-image display device according to the second embodiment will not be repeated.

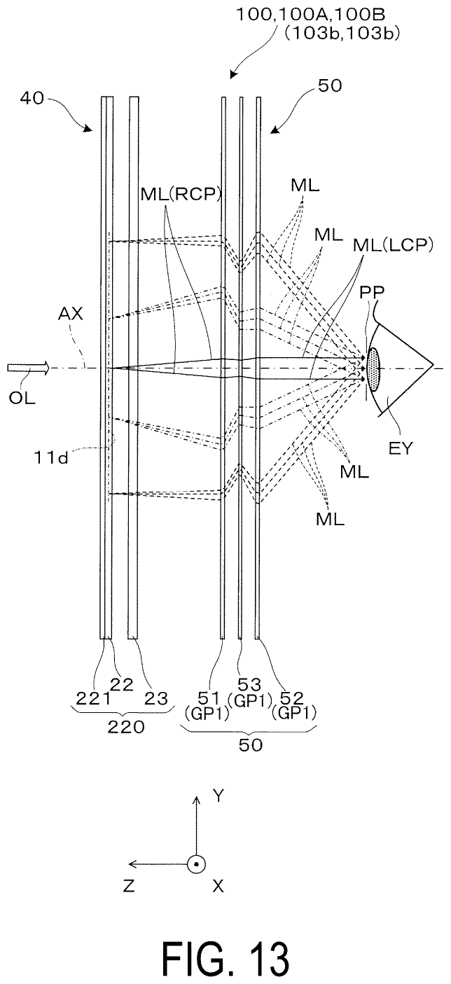

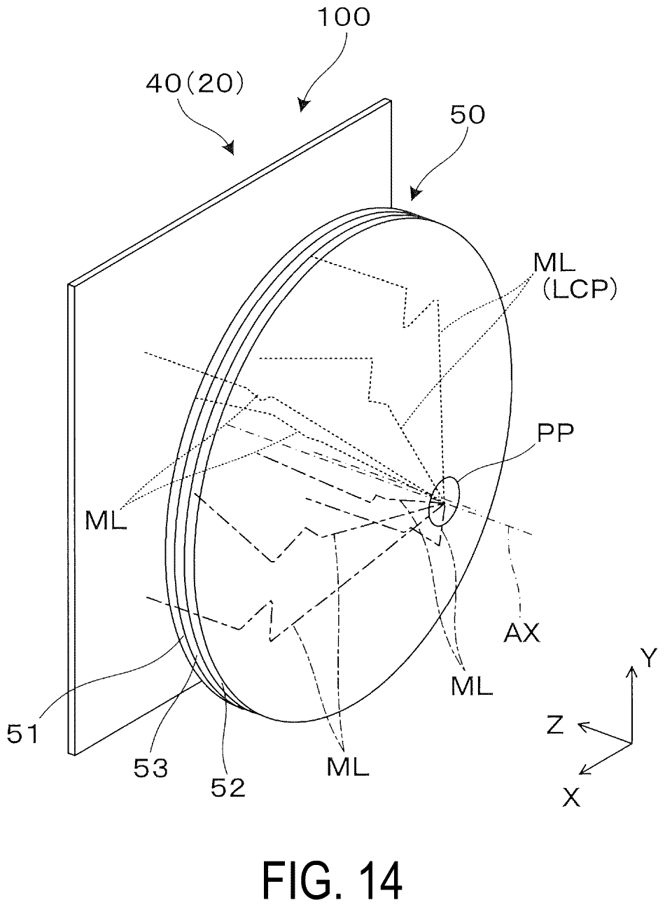

FIG. 13 is a side cross-sectional view used to describe a virtual-image display devices 100A and 100B or an optical unit 100 according to the fourth embodiment. FIG. 14 is a perspective view illustrating the optical unit 100. In a case of the present embodiment, in the imaging system 50, a third polarized-light diffraction lens 53 is disposed, in place of the switching half-wave plate 55 illustrated in FIGS. 5 and 11. In addition, in the imaging system 50, the polarized-light diffraction lens GP1 illustrated in FIG. 7 is used as the first polarized-light diffraction lens 51. Furthermore, the polarized-light diffraction lens GP1 illustrated in FIG. 7 is used as the second polarized-light diffraction lens 52. Moreover, the polarized-light diffraction lens GP1 illustrated in FIG. 7 is used as the third polarized-light diffraction lens 53. The first polarized-light diffraction lens 51, the third polarized-light diffraction lens 53, and the second polarized-light diffraction lens 52 are disposed in a separated state so as to be spaced apart from each other with a predetermined distance being provided between them.

In the imaging system 50, when the image light ML that enters from the display section 40 is the right circularly polarized light RCP, the first polarized-light diffraction lens 51 functions as an optical element having a positive power for the image light ML, and inverts the rotational direction of the polarized light to turn the light into the left circularly polarized light LCP while imparting the converging effect to the image light ML. As the image light ML that has passed through the first polarized-light diffraction lens 51 is the left circularly polarized light LCP, the third polarized-light diffraction lens 53 functions as an optical element having a negative power for the image light ML, and inverts the rotational direction of the polarized light to turn the light into the right circularly polarized light RCP while imparting the diverging effect to the image light ML. As the image light ML that has passed through the third polarized-light diffraction lens 53 is the right circularly polarized light RCP, the second polarized-light diffraction lens 52 inverts the rotational direction of the polarized light to turn the light into the left circularly polarized light LCP while imparting the converging effect to the image light ML. In this case, the imaging system 50 has a function similar to a lens system in which a concave lens is interposed between two convex lenses. Here, any power can be set as the power of each of the polarized-light diffraction lenses 51, 52, and 53, provided that the combined power of the imaging system 50 is positive.

Note that, although illustration is not given, when the image light ML of the left circularly polarized light LCP is caused to be outputted from the display section 40, it is possible to use the polarized-light diffraction lens GP1 illustrated in FIG. 7 as the first polarized-light diffraction lens 51, the second polarized-light diffraction lens 52, and the third polarized-light diffraction lens 53.

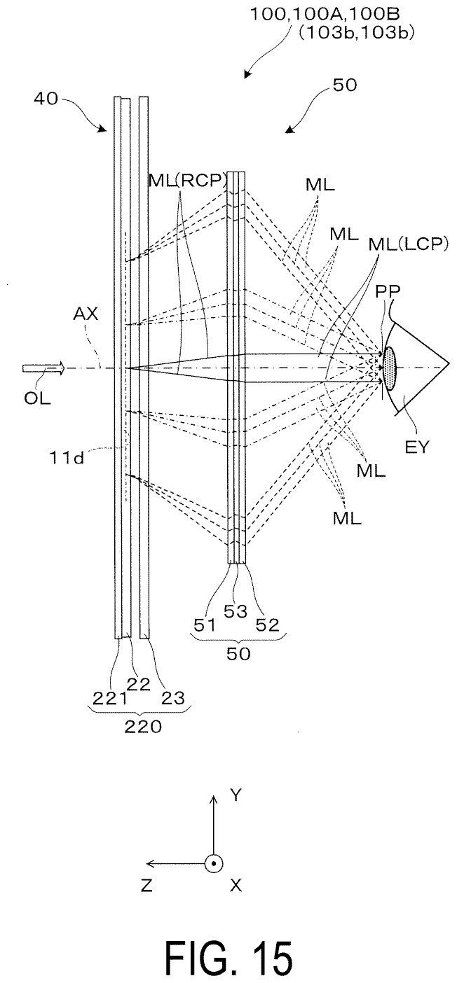

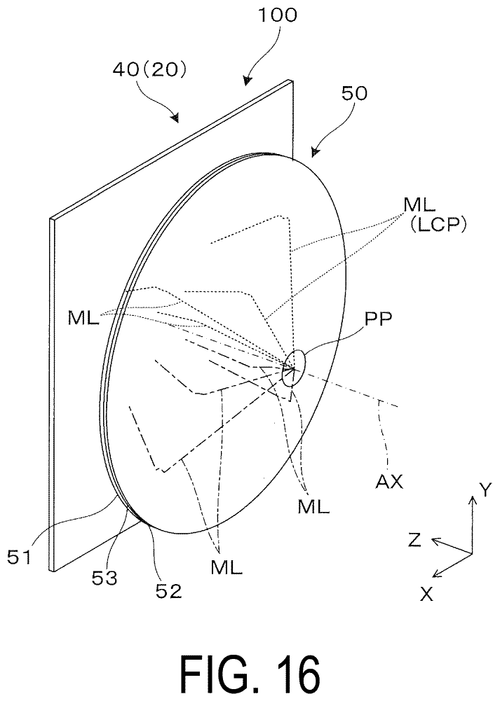

FIG. 15 is a side cross-sectional view used to describe a modification example of a virtual-image display devices 100A and 100B or an optical unit 100 illustrated in FIG. 13. FIG. 16 is a perspective view illustrating the optical unit 100. In this case, the polarized-light diffraction lens 51, the third polarized-light diffraction lens 53, and the second polarized-light diffraction lens 52 are disposed so as to be bonded to each other in a close contacted state.

### Fifth Embodiment

Below, a virtual-image display device according to a fifth embodiment or the like will be described. Note that the virtual-image display device according to the fifth embodiment is obtained by partially modifying the virtual-image display device according to the fourth embodiment, and explanation of portions common to the virtual-image display device according to the fourth embodiment will not be repeated.

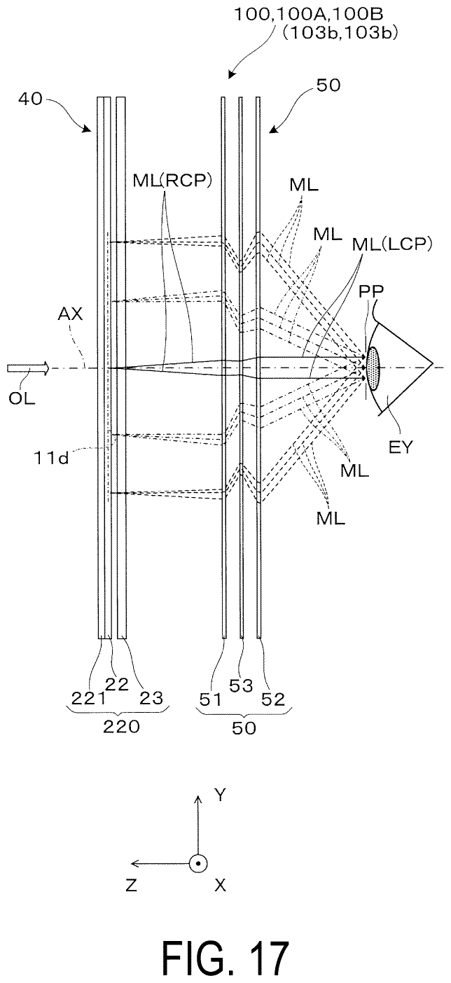

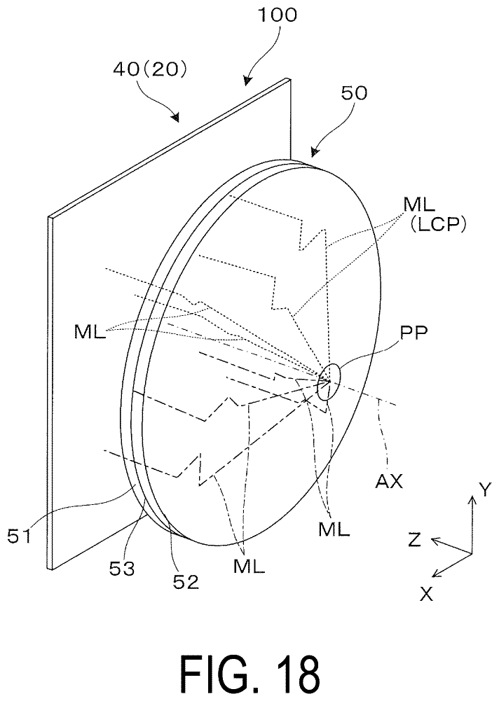

FIG. 17 is a side cross-sectional view used to describe a virtual-image display device 100A and 100B or an optical unit 100 according to the fifth embodiment. FIG. 18 is a perspective view illustrating the optical unit 100. In a case of the present embodiment, the imaging system 50 includes the first polarized-light diffraction lens 51, the third polarized-light diffraction lens 53, and the second polarized-light diffraction lens 52. In addition, the power of the polarized-light diffraction lens 51 and the lenses 52 and 53 and the distribution thereof are adjusted appropriately. Furthermore, the main beam of the image light ML outputted from the display section 40 extends substantially perpendicularly to the display surface 11d of the display section 40. That is, the imaging system 50 is telecentric at the display section 40 side. When the imaging system 50 is telecentric at the display section 40 side in this manner, the efficiency of accepting the image light ML from the display section 40 increases, which makes it possible to reduce the color unevenness occurring in a virtual image. That is, the imaging system 50 is able to display a favorable virtual image in which various types of aberration are reduced.

### Modification Examples and Others

These are descriptions of the present disclosure with reference to the embodiments. However, the present disclosure is not limited to the embodiments described above. It is possible to implement the present disclosure in various modes without departing from the main points of the disclosure. For example, the following modifications are possible.

The display section 40 and the composite display member 20 embedded in the display section 40 are not limited to those illustrated as an example in FIG. 3, and various types of display panels can be employed.

In the virtual-image display devices 100A and 100B in FIG. 17, the imaging system 50 includes three lenses: the polarized-light diffraction lens 51, and lenses 52 and 53. However, it is possible to employ a configuration in which the imaging system 50 includes four or more polarized-light diffraction lenses 51.

Although it has been assumed above that the HMD 200 is worn on the head and is used, the virtual-image display devices 100A and 100B may also be used as a hand-held display that is not worn on the head and is to be looked into like binoculars. That is, in the present disclosure, the hand-held display is included in the head-mounted display.

The virtual-image display device according to the specific aspect includes: a display section configured to output image light; a first polarized-light diffraction lens disposed so as to be opposed to the display section and having a positive power for the image light of circularly polarized light; and a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that is incident on the second polarized-light diffraction lens after passing through the first polarized-light diffraction lens.

In the virtual-image display device described above, the first polarized-light diffraction lens has a positive power for the image light of circularly polarized light from the display section, and the second polarized-light diffraction lens has a positive power for the passing image light of circularly polarized light that has passed through the first polarized-light diffraction lens and entered. Thus, with the thin imaging system including a pair of polarized-light diffraction lenses and having the reduced focal length, it is possible to observe an image formed on the display surface of the display section even when the display section is disposed in front of the eye. That is, it is possible to reduce the thickness of the virtual-image display device including the imaging system.

In the virtual-image display device described above, the first polarized-light diffraction lens and the second polarized-light diffraction lens include the distribution of refractive-index anisotropy within the flat surface, and a geometric phase corresponding to the shape of the lens is caused to occur for predetermined circularly polarized light.

The virtual-image display device according to the specific aspect further includes a wavelength plate disposed between the first polarized-light diffraction lens and the second polarized-light diffraction lens, and being configured such that the image light passing through the first polarized-light diffraction lens and turned from first circularly polarized light into second circularly polarized light is returned to the first circularly polarized light. In this case, by using the wavelength plate, it is possible to cause the first circularly polarized light to enter the second polarized-light diffraction lens. Thus, on the assumption that the first polarized-light diffraction lens and the second polarized-light diffraction lens are of the same type that exhibits a similar power property for circularly polarized light, it is possible to cause these lenses to function as a convex lens even if they have a plate shape.

In the virtual-image display device according to the specific aspect, the first polarized-light diffraction lens and the second polarized-light diffraction lens are configured such that the image light passing from a side of the display section is turned from right circularly polarized light that is the first circularly polarized light into left circularly polarized light that is the second circularly polarized light. That is, the first polarized-light diffraction lens and the second polarized-light diffraction lens convert the right circularly polarized light that enters, into the left circularly polarized light, and also output the light in a relatively converging state.

In the virtual-image display device according to the specific aspect, the first polarized-light diffraction lens and the second polarized-light diffraction lens are configured such that the image light passing from a side of the display section is turned from left circularly polarized light that is the first circularly polarized light into right circularly polarized light that is the second circularly polarized light. That is, the first polarized-light diffraction lens and the second polarized-light diffraction lens convert the left circularly polarized light that enters, into the right circularly polarized light, and also output the light in a relatively converging state.

The virtual-image display device according to the specific aspect is configured such that the wavelength plate includes a switching half-wave plate configured to switch into a first state and a second state, the first state being a state where the image light that passes through the first polarized-light diffraction lens is returned from the second circularly polarized light to the first circularly polarized light, the second state being a state where the image light that passes through the first polarized-light diffraction lens is caused to directly pass in a state of the second circularly polarized light, when the switching half-wave plate is in the first state, the display section is configured to output the image light that is the first circularly polarized light, and when the switching half-wave plate is in the second state, the display section is configured to cause external light to pass through. In this case, when the switching half-wave plate is in the first state, it is possible to observe, as a virtual image, an image formed on the display surface of the display section, and when the switching half-wave plate is in the second state, it is possible to directly observe the outside world. Such a virtual-image display device makes it possible to perform see-through display in which the image light and the external light are superimposed.

In the virtual-image display device according to the specific aspect, the first polarized-light diffraction lens turns the image light that passes through from a side of the display section, from first circularly polarized light to second circularly polarized light, and the second polarized-light diffraction lens turns the image light that passes through from a side of the first polarized-light diffraction lens, from the second circularly polarized light into the first circularly polarized light. In this case, on the assumption that the first polarized-light diffraction lens and the second polarized-light diffraction lens are of opposite types exhibiting inverted power properties for circularly polarized light, it is possible to cause these lenses to function as a convex lens even if they have a plate shape.

In the virtual-image display device according to the specific aspect, the first polarized-light diffraction lens turns the image light that passes through from a side of the display section, from right circularly polarized light that is the first circularly polarized light into left circularly polarized light that is the second circularly polarized light, and the second polarized-light diffraction lens turns the image light that passes through from a side of the first polarized-light diffraction lens, from left circularly polarized light that is the second circularly polarized light to right circularly polarized light that is the second circularly polarized light. That is, the first polarized-light diffraction lens converts the right circularly polarized light that enters, into the left circularly polarized light, and also outputs the light in a relatively converging state. The second polarized-light diffraction lens converts the left circularly polarized light that enters, into the right circularly polarized light, and also outputs the light in a relatively converging state.

In the virtual-image display device according to the specific aspect, the first polarized-light diffraction lens turns the image light that passes through from a side of the display section, from left circularly polarized light that is the first circularly polarized light into right circularly polarized light that is the second circularly polarized light, and the second polarized-light diffraction lens turns the image light that passes through from a side of the first polarized-light diffraction lens, from right circularly polarized light that is the second circularly polarized light into left circularly polarized light that is the first circularly polarized light.

In the virtual-image display device according to the specific aspect, the display section includes: an imager configured to form the image light; a polarizing plate configured to turn the image light outputted from the imager into predetermined linear polarization; and a quarter wavelength plate configured to turn the predetermined linear polarization into predetermined circularly polarized light. In this case, it is possible to turn the image light outputted from the display section into circularly polarized light.

The virtual-image display device according to the specific aspect further includes a third polarized-light diffraction lens disposed between the first polarized-light diffraction lens and the second polarized-light diffraction lens, and having a negative power for the image light turned into second circularly polarized light through the first polarized-light diffraction lens and caused to turn from the second circularly polarized light into the first circularly polarized light. In this case, with the imaging system obtained by combining the first polarized-light diffraction lens, the third polarized-light diffraction lens, and the second polarized-light diffraction lens together to achieve a desired focal length, it is possible to observe an image formed on the display surface of the display section.

In the virtual-image display device according to the specific aspect, a main beam of the image light outputted from the display section is perpendicular to a display surface of the display section. In this case, the imaging system makes it possible to display a favorable virtual image in which various types of aberration are reduced.

In the virtual-image display device according to the specific aspect, optical elements included in the first polarized-light diffraction lens to the second polarized-light diffraction lens is integrated. Such integration makes it possible to stabilize the optical performance of the imaging system and to reduce the thickness of the imaging system.

An optical unit according to the specific aspect includes: a display section configured to output image light; a first polarized-light diffraction lens disposed so as to be opposed to the display section and having a positive power for the image light of circularly polarized light; and a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that is incident on the second polarized-light diffraction lens after passing through the first polarized-light diffraction lens.

What is claimed is:

1. A virtual-image display device comprising:
a display section configured to output image light;
a first polarized-light diffraction lens disposed so as to be opposed to the display section and having a positive power for the image light of circularly polarized light; and
a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that is incident on the second polarized-light diffraction lens after passing through the first polarized-light diffraction lens.

2. The virtual-image display device according to claim 1, wherein
the first polarized-light diffraction lens and the second polarized-light diffraction lens include a distribution of refractive-index anisotropy formed within a flat surface, and cause a geometric phase corresponding to a shape of the lens to occur for predetermined circularly polarized light.

3. The virtual-image display device according to claim 1 further comprising:
a wavelength plate disposed between the first polarized-light diffraction lens and the second polarized-light diffraction lens, and being configured such that the image light passing through the first polarized-light diffraction lens and turned from first circularly polarized light into second circularly polarized light is returned to the first circularly polarized light.

4. The virtual-image display device according to claim 3, wherein
the first polarized-light diffraction lens and the second polarized-light diffraction lens are configured such that the image light passing from a side of the display section is turned from right circularly polarized light that is the first circularly polarized light into left circularly polarized light that is the second circularly polarized light.

5. The virtual-image display device according to claim 3, wherein
the first polarized-light diffraction lens and the second polarized-light diffraction lens are configured such that the image light passing from a side of the display section is turned from left circularly polarized light that is the first circularly polarized light into right circularly polarized light that is the second circularly polarized light.

6. The virtual-image display device according to claim 3, wherein
the wavelength plate includes a switching half-wave plate configured to switch into a first state and a second state, the first state being a state where the image light that passes through the first polarized-light diffraction lens is returned from the second circularly polarized light to the first circularly polarized light, the second state being a state where the image light that passes through the first polarized-light diffraction lens is caused to directly pass in a state of the second circularly polarized light,
when the switching half-wave plate is in the first state, the display section is configured to output the image light that is the first circularly polarized light, and
when the switching half-wave plate is in the second state, the display section is configured to cause external light to pass through.

7. The virtual-image display device according to claim 1,
wherein the first polarized-light diffraction lens turns the image light that passes from a side of the display section, from first circularly polarized light to second circularly polarized light, and
the second polarized-light diffraction lens turns the image light that passes from a side of the first polarized-light diffraction lens, from the second circularly polarized light to the first circularly polarized light.

8. The virtual-image display device according to claim 7, wherein
the first polarized-light diffraction lens turns the image light that passes from a side of the display section, from right circularly polarized light that is the first circularly polarized light to left circularly polarized light that is the second circularly polarized light, and
the second polarized-light diffraction lens turns the image light that passes from a side of the first polarized-light diffraction lens, from left circularly polarized light that is the second circularly polarized light to right circularly polarized light that is the first circularly polarized light.

9. The virtual-image display device according to claim 7, wherein
the first polarized-light diffraction lens turns the image light that passes from a side of the display section, from left circularly polarized light that is the first circularly polarized light to right circularly polarized light that is the second circularly polarized light, and
the second polarized-light diffraction lens turns the image light that passes from a side of the first polarized-light diffraction lens, from right circularly polarized light that is the second circularly polarized light to left circularly polarized light that is the first circularly polarized light.

10. The virtual-image display device according to claim 1, wherein
the display section includes:
an imager configured to form the image light;
a polarizing plate configured to turn the image light outputted from the imager into predetermined linear polarization; and
a quarter wavelength plate configured to turn the predetermined linear polarization into predetermined circularly polarized light.

11. The virtual-image display device according to claim 1 further comprising:
a third polarized-light diffraction lens disposed between the first polarized-light diffraction lens and the second polarized-light diffraction lens, and having a negative power for the image light turned into second circularly polarized light through the first polarized-light diffraction lens and caused to turn from the second circularly polarized light into the first circularly polarized light.

12. The virtual-image display device according to claim 11, wherein
a main beam of the image light outputted from the display section is perpendicular to a display surface of the display section.

13. The virtual-image display device according to claim 1, wherein
an optical element included in the first polarized-light diffraction lens to the second polarized-light diffraction lens is integrated.

14. An optical unit comprising:
a display section configured to output image light;
a first polarized-light diffraction lens disposed so as to be opposed to the display section and having a positive power for the image light of circularly polarized light; and
a second polarized-light diffraction lens disposed so as to be opposed to the display section with the first polarized-light diffraction lens being interposed between the second polarized-light diffraction lens and the display section, the second polarized-light diffraction lens having a positive power for the image light of circularly polarized light that is incident on the second polarized-light diffraction lens after passing through the first polarized-light diffraction lens.
